(19) United States
(12) Patent Application Publication
(10) Pub. No.: US 2008/0007174 A1
(43) Pub. Date: Jan. 10, 2008

(54) Plasma display apparatus

(76) Inventor: Hong Yeol Kim, Gumi-si (KR)

Correspondence Address: KED & ASSOCIATES, LLP, P.O. Box 221200, Chantilly, VA, 20153-1200, US

(21) Appl. No.: 11/723,886

(22) Filed: Mar. 22, 2007

(30) Foreign Application Priority Data
Jul. 7, 2006 (KR) 10-2006-0063991

(51) Int. Cl. H01J 17/49

(52) U.S. Cl. 313/582

(57) ABSTRACT

A plasma display apparatus includes a transparent electrode formed on an upper substrate, a black layer formed on the transparent electrode, and a bus electrode formed on the black layer, wherein the bus electrode is in contact with the transparent electrode at the outside of the region where the black layer is formed. Thus, the resistance value of the electrodes is reduced, and accordingly the driving voltage is also reduced, thereby improving power efficiency. Further, the plasma display apparatus is able to achieve an entirely uniform screen display and improves light room contrast, thereby improving the merchantability of the product.

This Nonprovisional application claims priority under 35 U.S.C. § 119(a) on Patent Application No. 10-2006-0063991 filed in Korea on Jul. 7, 2006, the entire contents of which are hereby incorporated by reference.

### BACKGROUND OF THE INVENTION

1. Field of the Invention

The present invention relates to a plasma display apparatus, and more particularly, to a plasma display apparatus which is able to improve the light room contrast of a panel and has such a structure that can reduce power consumption upon driving.

2. Description of the Conventional Art

A plasma display panel (hereinafter, referred to as a PDP) is an apparatus that displays images including characters and graphics by applying a predetermined voltage to electrodes installed in a discharge space to cause discharge, and allowing plasma generated in a gas discharge to excite phosphors, and has the advantages such as large-scale, lightweight and surface-thinning, vertically and laterally wide view angle, full color and high brightness.

Generally, a plasma display panel is an apparatus that displays images including characters and graphics by applying a predetermined voltage to electrodes installed in a discharge space to cause discharge, and allowing plasma generated in a gas discharge to excite phosphors.

In addition, the plasma display panel is being widely used as an image display apparatus which has a simple structure using plasma emission, and is not restricted in terms of installation position or the like due to it's a large screen, high picture quality and lightweight and thin design.

The plasma display panel is formed by forming a scan electrode and a sustain electrode on an upper substrate, and the scan electrode and the sustain electrode are formed of a transparent electrode, a black layer, and a bus electrode.

The black layer is formed between the transparent electrode and the bus electrode, and the transparent electrode and the bus electrode are electrically connected by Ag diffusion.

However, the plasma display panel according to the conventional art has the problem in that the black layer formed between the transparent electrode and the bus electrode separates the transparent and the bus electrode, and the transparent electrode and the bus electrode are electrically connected by Ag diffusion, thereby increasing the resistance value by Ag diffusion to deteriorate the jitter characteristics and increasing the discharge voltage.

### SUMMARY OF THE INVENTION

The present invention has been made in an effort to solve the above-said problems, and has for its object to provide a plasma display apparatus which improves light room contrast by having a black layer between a transparent electrode (ITO) and a bus electrode, is able to achieve a uniform screen display all over the panel by decreasing the resistance of the electrodes, and can reduce power consumption.

To achieve the above object, there is provided a plasma display apparatus according to a first feature of the present invention, including: a transparent electrode formed on an upper substrate; a black layer formed on the transparent electrode; and a bus electrode formed on the black layer, wherein the bus electrode comes into contact with the transparent electrode at the outside of the region where the black layer is formed.

Additionally, there is provided a plasma display apparatus according to a second feature of the present invention, including: a transparent electrode formed on an upper substrate; a black layer formed on the transparent electrode; and a bus electrode formed on the black layer, wherein the bus electrode is in contact with the transparent electrode at the outside of the region where the black layer is formed, and the width of the portion where the transparent electrode and the bus electrode are contacted with each other is 10 to 50% relative to the width of the black layer.

Additionally, there is provided a plasma display apparatus according to a third feature of the present invention, including: a transparent electrode formed on an upper substrate; a black layer formed on the transparent electrode; and a bus electrode formed on the black layer, wherein the bus electrode is in contact with the transparent electrode at the outside of the region where the black layer is formed, and the thickness of the bus electrode at the portion contacting the transparent electrode is 1.1 to 4 times the thickness of the bus electrode at the portion contacting the black layer.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating one embodiment of electrode arrangement of a plasma display apparatus;

FIG. 2 is a timing chart illustrating one embodiment of a method for dividing one frame into a plurality of subfields for time division driving;

FIG. 3 is a timing chart illustrating one embodiment of drive signals for driving the plasma display apparatus for each of the divided subfields;

FIG. 4 is a perspective view illustrating one embodiment of a structure of a plasma display apparatus according to the present invention;

FIG. 5 is a detailed cross-sectional view showing a first embodiment of an electrode structure of the plasma display panel;

FIG. 6 is a cross-sectional view illustrating the thickness of a bus electrode and a black layer of the plasma display apparatus according to the present invention;

FIG. 7 is a detailed cross-sectional view showing a second embodiment of an electrode structure of the plasma display panel;

FIG. 8 is a detailed cross-sectional view showing a third embodiment of an electrode structure of the plasma display panel;

FIG. 9 is a detailed cross-sectional view showing a fourth embodiment of an electrode structure of the plasma display panel; and

FIG. 10 is a detailed cross-sectional view showing a fifth embodiment of an electrode structure of the plasma display panel.

### DETAILED DESCRIPTION OF THE PREFERRED EMBODIMENTS

Hereinafter, preferred embodiments of the present invention will be described in detail with reference to the accompanying drawings.

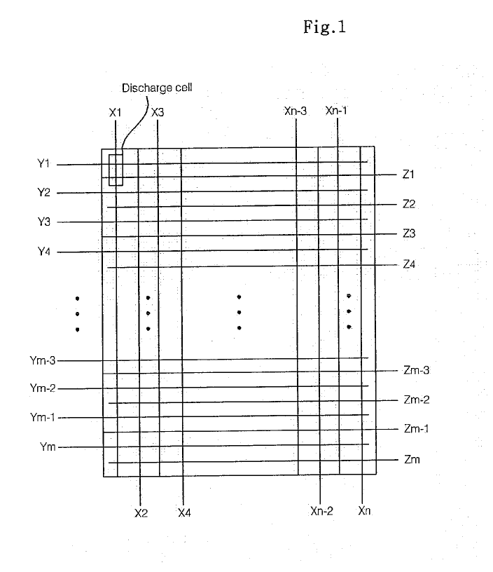

FIG. 1 is a view illustrating one embodiment of electrode arrangement of a plasma display apparatus. Preferably, a plurality of discharge cells of the plasma display panel is arranged in a matrix pattern as shown in FIG. 1. The plurality of discharge cells are formed at every intersection of Y1 to Ym, sustain electrode lines Z1 to Zm and address electrode lines X1 to Xn. The scan electrode lines Y1 to Ym may be sequentially or simultaneously driven, and the sustain electrode lines Z1 to Zm may be simultaneously driven. The address electrode lines X1 to Xn may be divided into are driven divided into odd numbered lines and even numbered lines or sequentially driven.

The electrode arrangement as shown in FIG. 1 is only one embodiment of electrode arrangement of the plasma display panel according to the present invention. Thus, the present invention is not limited to the electrode arrangement and driving method of the plasma display panel as shown in FIG. 1. For instance, a dual scan method for simultaneously scanning two of the scan electrode lines Y1 to Ym is also applicable. Further, the address electrode lines X1 to Xn may be driven divided into upper and lower parts at the center portion of the panel.

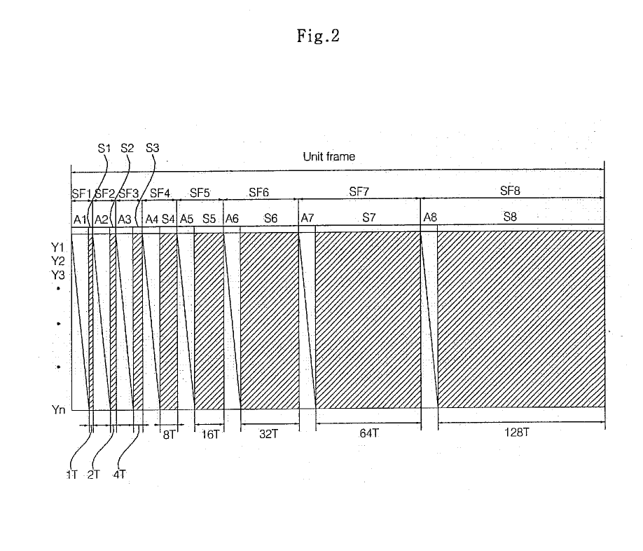

FIG. 2 is a timing chart illustrating one embodiment of a method for dividing one frame into a plurality of subfields for time division driving. A unit frame may be divided into a predetermined number of subfields, for example, eight subfields SF1 through SF8, to implement time division gray scale display. The subfields SF1, . . . , SF8 may be respectively divided into reset periods (not shown), address periods A1, . . . , A8, and sustain periods S1, . . . , S8.

According to one embodiment of the present invention, the reset period of at least one of the plurality of the subfields may be omitted. For example, the reset period may only exist in the first subfield, or only in the subfield in the middle portion of the entire subfields.

During the address periods A1, . . . , A8, a display data signal is applied to the address electrodes X, and corresponding scanning pulses are sequentially applied to the scan electrodes Y

During the sustain periods S1, . . . , S8, a sustain discharge pulse is alternately applied to the scan electrodes Y and sustain electrodes Z n so that a sustain discharge occurs in discharge cells in which wall charges were formed during the previous address periods A1, . . . , A8.

A PDP's brightness is proportional to the number of sustain discharge pulses applied during sustain discharge periods S1, . . . , S8 in a unit frame. If a frame forming one image is displayed by 8 subfields in 256 gray-scales, different numbers (1, 2, 4, 8, 16, 32, 64, and 128) of sustain pulses may be sequentially assigned to the subfields. In this case, in order to obtain the brightness of a 133 gray-scale level, cells may be addressed and sustain-discharged during the periods of a first subfield, a third subfield, and an eighth subfield.

The number of sustain-discharges assigned to each subfield depends on a weight of the subfield based on Automatic Power Control (APC). That is, although FIG. 2 has illustrated the case where one frame is divided into eight subfields, the present invention is not limited thereto, and the number of subfields forming one frame can also be variously changed according to a design rule. For example, one frame may be divided into more than 8 subfields, e.g., 12 or 16 subfields, so as to driven the plasma display panel.

Alternately, the number of sustain-discharges assigned to each subfield can be variously set considering gamma characteristics or panel characteristics. For example, it is possible to decrease a gray-scale level assigned to a fourth subfield from 8 to 6 and increase a gray-scale level assigned to a sixth subfield from 32 to 34.

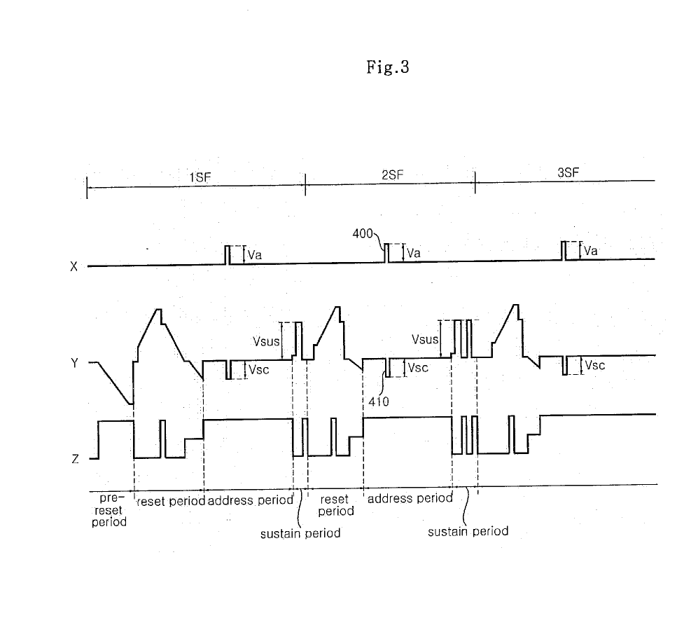

FIG. 3 is a timing chart illustrating one embodiment of drive signals for driving the plasma display apparatus for each of the divided subfields.

The subfield includes a pre reset period for forming positive wall charges on the scan electrodes Y and forming negative wall charges on the sustain electrodes Z; a reset period for initializing discharge cells of a whole screen by using the distribution of wall charges formed in the pre reset period; an address period for selecting the discharge cell; and a sustain period for sustaining discharge of the selected discharge cells.

The reset period includes a set-up period and a set-down period. During the setup period, a ramp-up waveform is simultaneously applied to all scan electrodes Y. The ramp-up waveform generates a weak discharge within all of the discharge cells, which causes wall charges within the cells. During the set-down period, a ramp-down waveform which falls from a positive voltage that is lower than the peak voltage of the ramp-up waveform is simultaneously applied to all scan electrodes Y. The ramp-down waveform causes a weak erasure discharge within all the discharge cells, thereby erasing excessive charges among wall charges and space charges generated by the set up discharge.

In the address period, a negative scan signal is sequentially applied to the scan electrodes, and a positive data signal is applied to the address electrodes X. A voltage difference between the scan signal and the data signal adds to a wall voltage generated during the reset period, to generate an address discharge within the discharge cells, thereby selecting a cell. During the set-down period and the address period, a signal that holds sustain voltage level Vs is supplied to the sustain electrodes Z.

During the sustain period, a sustain pulse is alternately supplied to the scan electrode and the sustain electrode, to generate a sustain discharge as a surface discharge type between the scan electrodes and the sustain electrodes.

Drive waveforms as shown in FIG. 3 are one embodiment of the signals for driving the plasma display panel according to the present invention, and the present invention is not limited by the waveforms as shown in FIG. 3. For example, the pre-reset period may be omitted, and the polarities and voltage levels of the drive signals as shown in FIG. 3 can be changed as needed. An erase signal for erasing wall charges may be applied to the sustain electrodes after completion of the sustain discharge. Alternately, it is possible to perform single sustain driving in which the sustain signal is applied only to either the scan electrodes Y or the sustain electrodes Z, thereby causing a sustain discharge.

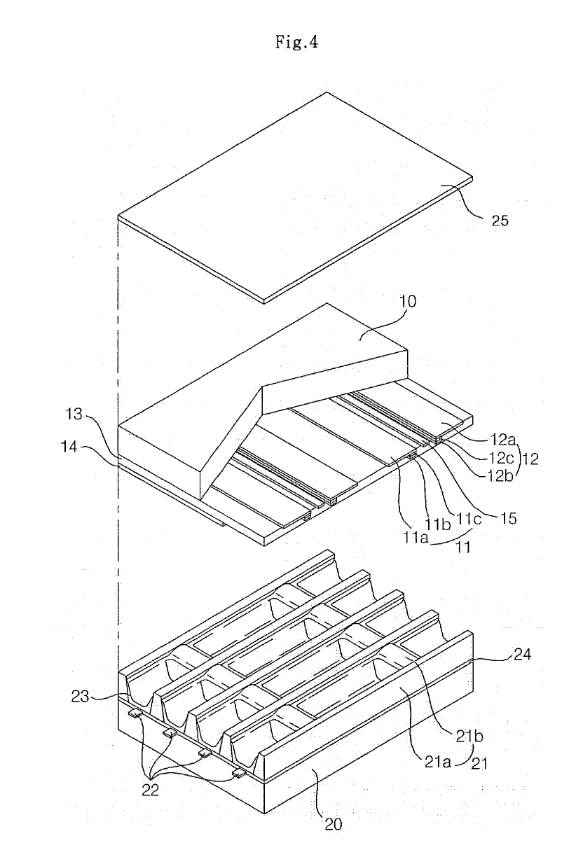

FIG. 4 is a perspective view illustrating one embodiment of a structure of a plasma display apparatus according to the present invention.

The plasma display panel as shown in FIG. 4 includes sustain electrode pairs, i.e., a scan electrode 11 and a sustain electrode 12, formed on an upper substrate 10, and an address electrode 22 formed on a lower substrate 20.

The sustain electrode pairs 11 and 12 include transparent electrodes 11a and 12a generally formed of ITO (Indium Tin Oxide) and bus electrodes 11b and 12b. The bus electrodes 11b and 12b may be formed of metal such as Ag, Cr, etc. or a lamination of Cr/Cu/Cr or a lamination of Cr/Al/Cr. The bus electrodes 11b and 12b are formed on the transparent electrode 11a and 12a, and serves to reduce a voltage drop caused by the transparent electrodes 11a and 12a having high resistance.

Meanwhile, the sustain electrode pairs 11 and 12 have a laminated structure of the transparent electrodes 11a and 12a and the bus electrodes 11b and 12b. The bus electrodes 11b and 12b may be made of various materials, such as photosensitive Ag, in addition to the materials listed above.

A black matrix (BM) 15 arranged between the transparent electrodes 11a and 12a and bus electrodes 11b and 12b of the scan electrodes 11 and sustain electrodes 12, absorbs the external light generated from the outside of the upper substrate 10 and reduces reflection of the external light, thereby improving purity and contrast of the upper substrate 10.

The black matrix 15 is formed on the upper substrate 10, i.e., at portions overlapping with barrier ribs 21. Further, black layers 11c and 12c are formed between the transparent electrodes 11a and 12a and the bus electrodes 11b and 12b. The black matrix 15 and the black layers 11c and 12c are simultaneously formed in the formation procedure, and may be physically connected with each other or separated from each other so that they are not physically connected.

If they are physically connected, the black matrix 15 and the black layers 11c and 12c are formed of the same material. On the other hand, if they are physically separated, the black matrix 15 and the black layers 11c and 12c may be formed of different material.

Alternately, the black matrix 15 may not be formed, but only the black layers 11c and 12c may be formed integrally.

An upper dielectric layer 13 and a protective film 14 are laminated on the upper substrate 10 where the scan electrodes 11 and the sustain electrodes 12 are formed parallel to each other. Charged particles generated by discharge are accumulated on the upper dielectric layer 13, and is able to serve to protect the sustain electrode pairs 11 and 12. The protective film 14 protects the upper dielectric layer 13 from sputtering of the charged particles generated upon gas discharging and to increase emission efficiency of secondary electrons. Further, the protection film 14 is typically formed using magnesium oxide (MgO) or Si—MgO containing silicon (Si) therein. The content of silicon (Si) to be added to the protective film 14 may be from 50 PPM to 200 PPM relative to weight percent (wt %).

Meanwhile, the address electrode 22 is formed in a direction intersecting the scan electrode 11 and the sustain electrode 12. A lower dielectric layer 24 and barrier ribs are formed on the lower substrate 20, in which the address electrode 22 is formed.

A phosphorous material layer 23 is formed on the surfaces of the lower dielectric layer 24 and the barrier ribs 21. The barrier ribs 21 are formed by longitudinal barrier ribs 21a and horizontal barrier ribs 21b that are formed in an enclosed type to physically divide the discharge cells, thus preventing ultraviolet and a visible ray generated by the discharge from leaking toward neighboring discharge cells.

Referring to FIG. 4, a filter 25 is preferably formed on the entire surface of the plasma display panel according to the present invention. The filter 25 may include an external light blocking layer, an anti-reflection (AR) layer, a near infrared (NIR) shielding layer or electromagnetic interference (EIMI) shielding layer and so on.

If the distance between the filter 25 and the panel is 10 to 30 μm, light incident from outside can be effectively blocked, and the light generated from the panel can be effectively emitted to the outside. Further, in order to protect the panel from pressure or the like from the outside, the distance between the filter 25 and the panel can be set to 30 to 120 μm.

An adhesive layer to be attached to the filter 25 and the panel can be formed between the filter 25 and the panel.

In the present invention, it is possible to apply a structure of barrier ribs of various shapes, as well as a structure of the barrier ribs 21 as shown in FIG. 4, for instance, a differential type barrier rib structure in which the vertical barrier ribs 21a and the horizontal barrier ribs 21b have a different height, a channel type barrier rib structure in which a channel useable as an exhaust passage is formed on one or more of the vertical barrier ribs 21a or horizontal barrier ribs 21b, a hollow type barrier rib structure in which a hollow is formed on one or more of the vertical barrier ribs 21a or horizontal barrier ribs 21b and so on.

In case of the differential type barrier rib structure, it is preferred that the height of the horizontal barrier ribs 21b is greater, while in case of the channel type barrier rib structure or hollow type barrier ribs structure, it is preferred that a channel or hollow is formed on the horizontal barrier ribs 21b.

Although the present invention has been illustrated and explained with respect to the case where R, G, and B discharge cells are respectively arranged on the same line, they can be arranged in a different form. For example, a delta type arrangement where the R, G, and B discharge cells are arranged in a triangle is also applicable. Further, the discharge cells may be polygons of various shapes including a pentagon and a hexagon, as well as a rectangle.

The phosphorous material layer 23 emits light by ultraviolet rays generated upon gas discharge to thus generate visible light of any one of red (R), green (G) and blue (B). An inert mixed gas for discharge, such as He+Xe, Ne+Xe or He+Ne+Xe, is injected into discharge spaces defined between the upper substrate 10 and the barrier ribs 21 and between the lower substrate 20 and the barrier ribs 21.

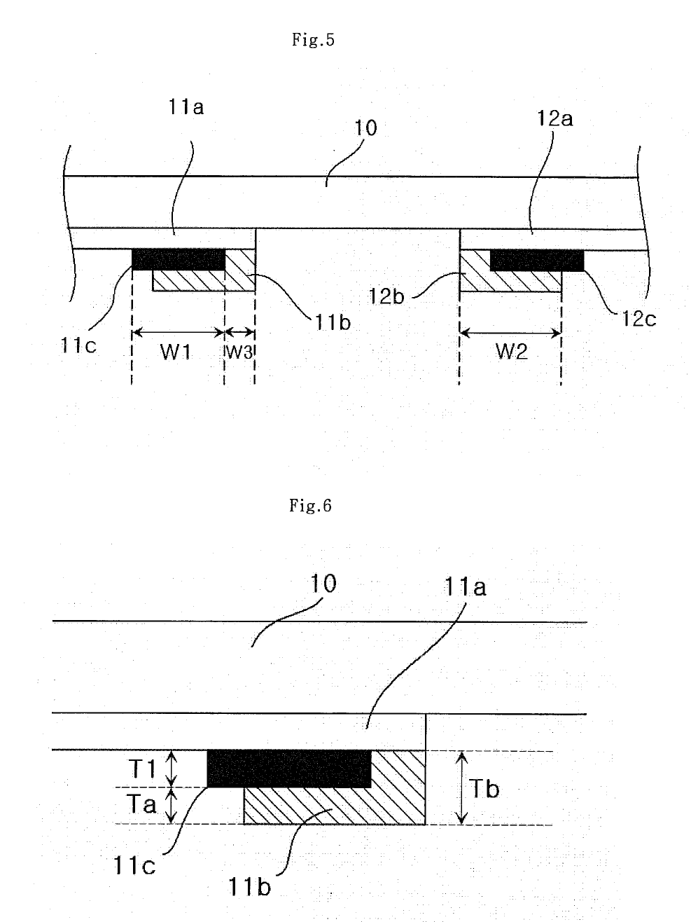

Embodiments of an electrode structure of the plasma display apparatus according to the present invention will be described in detail with reference to FIGS. 5 to 10.

FIG. 5 is a detailed cross-sectional view showing a first embodiment of an electrode structure of the plasma display panel.

Referring to FIG. 5, in the first embodiment of the plasma display apparatus according to the present invention, bus electrodes 11b and 12b are laminated on black layers 11c an 12c and transparent electrodes 11a and 12a.

That is, the bus electrodes 11b and 12b are in contact with the transparent electrodes at the outside of the regions where the black layers 11c and 12c are formed. Thus, the bus electrodes 11b and 12b have portions contacting the black layers 11c and 12c and portions contacting the transparent electrodes 11a and 12a.

The portions contacting the transparent electrodes 11a and 12a are lateral edge outer portions of the black layers 11c and 12c.

Especially, in the first embodiment of the present invention, the bus electrodes 11b and 12b are in contact with the transparent electrodes 11a and 12a at the outside of the lateral edges of the black layers close to barrier ribs.

Here, the scan electrodes 11a and 11b and the sustain electrodes 12a and 12b are not electrodes within the same discharge cell, but are two electrodes adjacent to each other formed between two discharge cells neighboring with the barrier ribs formed therebetween. Therefore, barrier ribs are formed between the scan electrodes 11a and 11b and the sustain electrodes 12a and 12b. For reference, the barrier ribs are omitted in the drawings.

The bus electrodes 11b and 12b are formed so that they do not fully cover the black layers 11c and 12c but the ends of the black layers 11c and 12c are exposed to some extent.

The width of the transparent electrodes 11a and 12a may be from 190 to 250 [symbol] or wider than that, i.e., 240 to 310 [symbol] The thickness thereof is preferably less than 1 μm but not limited thereto.

The width W2 of the bus electrodes 11b and 12b is equal to or wider than the width W1 of the black layers 11c and 12c.

Further, the width W2 of the bus electrodes 11b and 12b is preferably greater than 1 time and less than 1.5 times the width W1 of the black layers 11c and 12c.

By way of one example, the width W2 of the bus electrodes 11b and 12b may be from 60 to 110 [symbol] If the width W2 of the bus electrode is less than 60 [symbol] the effect of resistance decrease is slight due to the small thickness of the electrodes, thereby increasing driving voltage. If the width W2 of the bus electrodes is greater than 110 [symbol] the aperture ratio of the discharge cells is reduced, which may decrease luminance.

Further, the width W3 of the portions where the transparent electrodes 11a and 12a and the bus electrodes 11b and 12b are in contact with each other is set to 10 to 50% relative to the width of the black layers 11c and 12c.

If the width W3 is less than 10%, the area of the bus electrodes 11b and 12b gets narrower, thereby lowering electrical resistance reduction rate attributed to the bus electrodes 11b and 12b. If the width W3 is greater than 50%, the aperture ratio of the discharge cells is reduced, thereby degrading luminance.

FIG. 6 is a cross-sectional view illustrating the thickness of a bus electrode and a black layer of the plasma display apparatus according to the present invention.

The plasma display apparatus according to the present invention is configured such that the thickness Tb of the portions where the bus electrodes 11b and 12b are in contact with the transparent electrodes 11a and 12a and the thickness Ta of the portions where the bus electrodes 11b and 12b are in contact with the black layers 11c and 12c.

The thickness Tb of the portions where the bus electrodes 11b and 12b are in contact with the transparent electrodes 11a and 12a is 1.1 to 4 times the thickness Ta of the portions of the bus electrodes 11b and 12b contacting the black layers 11c and 12c.

Preferably, the thickness Ti of the black layers 11c and 12c is approximately less than 11 [symbol] .

In the present invention, the bus electrodes 11b and 12b are formed so as to be in direct contact with the transparent electrodes 11a and 12a, which leads to the effect of electrical resistance reduction of the electrodes. Also, as in the conventional art, electrical resistance is reduced by the phenomenon that Ag component of the bus electrodes laminated on the black layers 11c and 12c are diffused over the black layers 11c and 12c, thereby increasing the effect of resistance reduction.

Accordingly, in order to increase the effect of resistance reduction, if the thickness of the black layers 11c and 12c is not less than 11 [symbol] but greater than that, the effect of conductive components of the bus electrodes 11b and 12b laminated on the black layers 11c and 12c passing through the black layers 11c and 12c and being diffused up to the transparent electrodes may be slight.

The thickness Ta of the portions where the bus electrodes 11b and 12b are in contact with the black layers 11c and 12c is approximately 5 to 10 [symbol] If the thickness Ta is too small, this increases electrical resistance as compared to the case of a large thickness. Thus, it is preferred to provide the above-mentioned thickness by taking the structure of the panel into account.

Moreover, it is preferred that the thickness Tb of the portions where the bus electrodes 11b and 12b are in contact with the transparent electrodes 11a and 12a is approximately 16 to 21 [symbol] by taking the thickness of the black layers 11c and 12c into account.

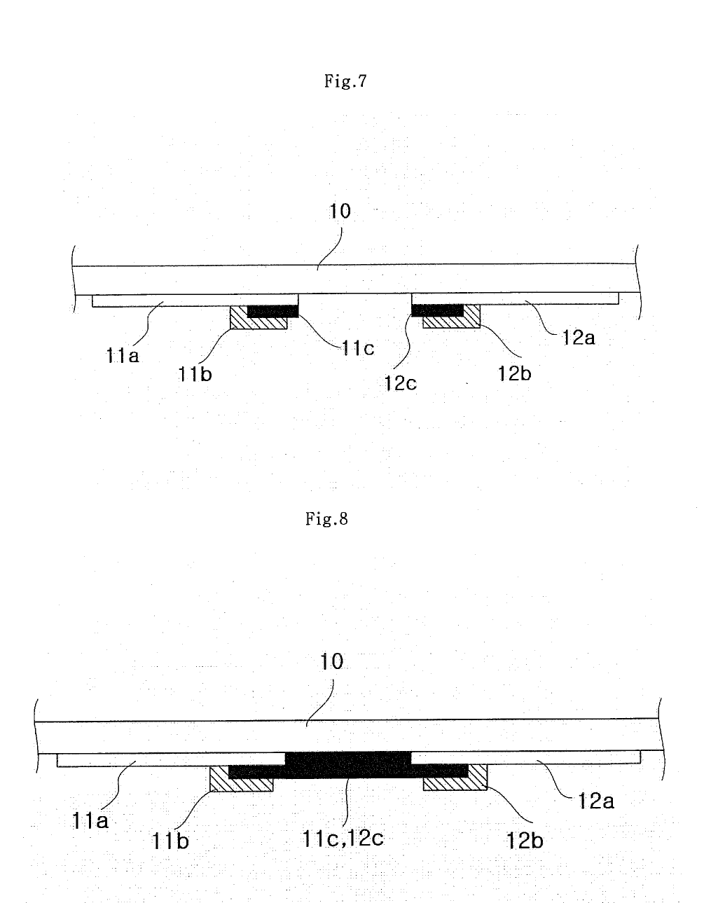

FIG. 7 is a detailed cross-sectional view showing a second embodiment of an electrode structure of the plasma display panel.

Referring to FIG. 7, in the second embodiment of the plasma display apparatus according to the present invention, the bus electrodes 11b and 12b are formed so as to be in contact with the transparent electrodes 11a and 12a at the outside of the lateral edges of the black layers 11c and 12c not in the direction of barrier ribs but in the direction of discharge spaces.

That is, the second embodiment of the present invention is configured so that the bus electrodes 11b and 12b are in contact with the transparent electrodes 11a and 12a in the direction opposite to that of the first embodiment.

The other components of the present invention are substantially the same as those of the first embodiment.

FIG. 8 is a detailed cross-sectional view showing a third embodiment of an electrode structure of the plasma display panel.

Referring to FIG. 8, the third embodiment of the plasma display apparatus according to the present invention is configured such that the black layers 11c and 12c in the second embodiment are connected to each other.

Because the scan electrodes 11a and 11b and the sustain electrodes 12a and 12b are the pairs of electrodes adjacent to each other with barrier ribs as the boundaries, there is no big influence on the aperture ratio of the discharge cells.

Since upper portions of the barrier ribs are covered by the black layers 11c and 12c, light room contrast is further improved. That is, in this embodiment, the black layers 11c and 12c also function as a black matrix as described in FIG. 4.

The other components of the present invention are substantially the same as those of the second embodiment.

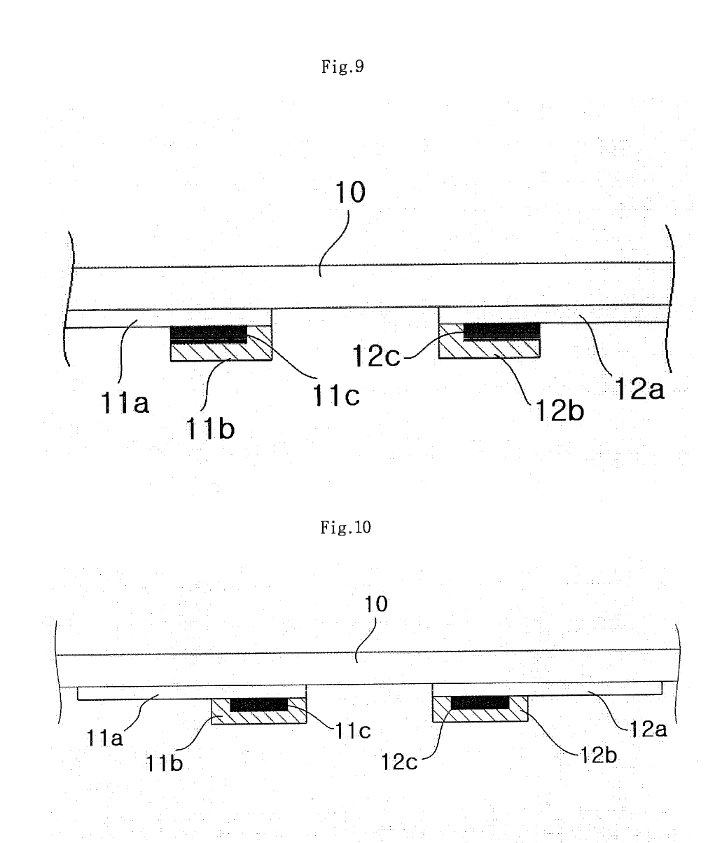

FIG. 9 is a detailed cross-sectional view showing a fourth embodiment of an electrode structure of the plasma display panel.

Referring to FIG. 9, the fourth embodiment of the plasma display apparatus according to the present invention is configured such that the ends of the bus electrodes 11b and 12b formed on the black layers 11c and 12c in the first or second embodiment extend to be in an array with the ends of the black layers 11c and 12c.

FIG. 9 illustrates a modification of the first embodiment of the present invention. Although not shown, the embodiment in which the portions where the bus electrodes 11b and 12b are in contact with the transparent electrodes 11a and 12a are formed in the opposite direction is included in this embodiment.

As the cross sectional area of the bus electrodes 11a and 11b increases, the electrical resistance of the entire electrodes is further reduced than in the first or second embodiment.

The other components of the present invention are substantially the same as those of the first or second embodiment.

FIG. 10 is a detailed cross-sectional view showing a fifth embodiment of an electrode structure of the plasma display panel.

Referring to FIG. 10, the fifth embodiment of the plasma display apparatus according to the present invention is configured such that the bus electrodes 11b and 12b are in contact with the transparent electrodes 11a and 12a at the outside of the lateral edges of the black layers 11c and 12c and cover the black layers 11c and 12c.

In this embodiment, the area of the bus electrodes 11b and 12b contacting the transparent electrodes 11a and 12a is wider than those of the preceding embodiments, thereby further decreasing the electrical resistance of the entire electrodes.

However, the width of the bus electrodes 11b and 12b should be properly adjusted so that the aperture ratio of the discharge cells are not lowered, and accordingly the width of the black layers 11c and 12c also should be properly adjusted.

It is possible to improve aperture ratio and increase electrically resistance reduction by making smaller the width of the bus electrodes 11b and 12b contacting the transparent electrodes 11a and 12a at one side of the outer portions of the black layers than those of the first or second embodiment

The other components of the present invention are substantially the same as those of the first or second embodiment.

The thus-configured plasma display apparatus according to the present invention can reduce a resistance value between the bus electrodes and the transparent electrodes, and accordingly reduce a driving voltage because the bus electrodes of the scan electrodes and sustain electrodes formed on the upper substrate are formed to be in contact with the transparent electrodes at the outside of the regions where the black layers are formed, thereby improving power efficiency.

Furthermore, the plasma display apparatus according to the present invention is able to implement an entirely uniform screen display and improve light room contrast, thereby improving the merchantability of the product.

Although the invention has been described with reference to the illustrations, drawings, it is to be understood that the invention is not to be limited to the disclosed embodiments and drawings but, on the contrary, is intended to cover various modifications and equivalent arrangements within the scope of the following claims.

What is claimed is:

1. A plasma display apparatus, comprising:
a transparent electrode formed on an upper substrate;
a black layer formed on the transparent electrode; and
a bus electrode formed on the black layer,
wherein the bus electrode is in contact with the transparent electrode at the outside of the region where the black layer is formed.

2. The plasma display apparatus of claim 1, wherein the bus electrodes are in contact with the transparent electrodes at both sides of the regions where the black layers are formed.

3. The plasma display apparatus of claim 1, wherein the width of the bus electrodes is greater than the width of the black layers.

4. The plasma display apparatus of claim 1, wherein the width of the bus electrodes is greater than 1 time and less than 1.5 times the width of the black layers.

5. The plasma display apparatus of claim 1, wherein the width of the portions where the transparent electrodes and the bus electrodes are in contact with each other is 10 to 50% relative to the width of the black layer.

6. The plasma display apparatus of claim 1, wherein the width of the bus electrodes is 60 to 110

[symbol]

7. The plasma display apparatus of claim 1, wherein the thickness of the portions of the bus electrodes contacting the transparent electrodes is different from the thickness of the portions thereof contacting the black layers.

8. The plasma display apparatus of claim 1, wherein the thickness of the black layers is less than 11

[symbol]

9. The plasma display apparatus of claim 1, wherein the thickness of the portions of the bus electrodes contacting the black layers is 5 to 10

[symbol]

10. The plasma display apparatus of claim 1, wherein the thickness of the portions of the bus electrodes contacting the transparent electrodes is 16 to 21

[symbol]

11. A plasma display apparatus, comprising:
a transparent electrode formed on an upper substrate;
a black layer formed on the transparent electrode; and
a bus electrode formed on the black layer,
wherein the bus electrode comes into contact with the transparent electrode at the outside of the region where the black layer is formed, and the width of the portion where the transparent electrode and the bus electrode are contacted with each other is 10 to 50% relative to the width of the black layer.

12. The plasma display apparatus of claim 11, wherein the width of the bus electrodes is greater than the width of the black layers.

13. The plasma display apparatus of claim 11, wherein the width of the bus electrodes is greater than 1 time and less than 1.5 times the width of the black layers.

14. The plasma display apparatus of claim 11, wherein the thickness of the portions of the bus electrodes contacting the transparent electrodes is different from the thickness of the portions thereof contacting the black layers.

15. The plasma display apparatus of claim 11, wherein the thickness of the portions of the bus electrodes contacting the black layers is 5 to 10

[symbol]

16. The plasma display apparatus of claim 11, wherein the thickness of the portions of the bus electrodes contacting the transparent electrodes is 16 to 21

[symbol]

17. A plasma display apparatus, comprising:
a transparent electrode formed on an upper substrate;
a black layer formed on the transparent electrode; and
a bus electrode formed on the black layer,
wherein the bus electrode comes into contact with the transparent electrode at the outside of the region where the black layer is formed, and the thickness of the bus electrode at the portion contacting the transparent electrode is 1.1 to 4 times the thickness of the bus electrode at the portion contacting the black layer.

18. The plasma display apparatus of claim 17, wherein the width of the bus electrodes is greater than the width of the black layers.

19. The plasma display apparatus of claim 17, wherein the thickness of the portions of the bus electrodes contacting the black layers is 5 to 10

[symbol]

20. The plasma display apparatus of claim 17, wherein the thickness of the portions of the bus electrodes contacting the transparent electrodes is 16 to 21 [symbol]
